(19) United States
(12) Patent Application Publication
(10) Pub. No.: US 2014/0349854 A1
(43) Pub. Date: Nov. 27, 2014

(54) IRON-BASED SUPERCONDUCTING MATERIAL, IRON-BASED SUPERCONDUCTING LAYER, IRON-BASED SUPERCONDUCTING TAPE WIRE MATERIAL, AND IRON-BASED SUPERCONDUCTING WIRE MATERIAL

(71) Applicant: International Superconductivity Technology Center, Kanagawa-ken (JP)

(72) Inventors: Masashi Miura, Tokyo (JP); Seiji Adachi, Narashino-shi (JP); Keiichi Tanabe, Kawasaki-shi (JP); Hideo Hosono, Yokohama-shi (JP)

(73) Assignee: International Superconductivity Technology Center, Kanagawa-ken (JP)

(21) Appl. No.: 14/193,800

(22) Filed: Feb. 28, 2014

(30) Foreign Application Priority Data
May 24, 2013 (JP) 2013-110254

(51) Int. Cl. H01B 12/02

(52) U.S. Cl. CPC H01B 12/02
USPC 505/100; 505/230; 252/519.12; 252/519.14; 252/519.15; 174/102 R

(57) ABSTRACT

Provided is an iron-based superconducting material including an iron-based superconductor having a crystal structure of ThCr₂Si₂, and nanoparticles which are expressed by BaXO₃ (X represents one, two, or more kinds of elements selected from a group consisting of Zr, Sn, Hf, and Ti) and have a particle size of 30 nm or less. The nanoparticles are dispersed in a volume density of 1×10²¹m⁻³ or more.

### CROSS REFERENCE TO RELATED APPLICATIONS

This application claims priority from Japanese Patent Application No. 2013-110254, filed on May 24, 2013, the contents of which are incorporated herein by reference in their entirety.

### BACKGROUND OF THE INVENTION

1. Field of the Invention

The present invention relates to an iron-based superconducting material, an iron-based superconducting layer, an iron-based superconducting tape wire material, and an iron-based superconducting wire material.

2. Description of Related Art

Recently, the development of copper oxide superconductors such as a Bi-based copper oxide superconductor and an Y-based copper oxide superconductor has been actively conducted. In addition, for practical use of the copper oxide superconductor, an attempt has been made to use the copper oxide superconductor as a conductor or a superconducting coil for a power supply and the like after processing the copper oxide superconductor into a wire material.

The Bi-based copper oxide superconducting wire material has a sheath wire material structure which is obtained by covering a Bi-based superconducting layer with an Ag sheath material according to a Powder In Tube (PIT) method and the like. In contrast, the Y-based copper oxide superconducting wire material employs a tape wire material structure in which a Y-based copper oxide superconducting layer is laminated on a tape-shaped metallic base material through an intermediate layer according to a film forming method such as a pulsed laser deposition method (PLD method).

On the other hand, as a new high-temperature superconductor group subsequent to the copper oxide superconductor, an iron-based superconductor was developed in 2008. As shown in FIGS. 1A to 1C, as the iron-based superconductor, various superconductors having a different structure such as a 1111-type compound (NdFeAs(O, F) as an example, refer to FIG. 1A) having a ZrCuSiAs crystal structure which exhibits the critical temperature (T_{c}) of approximately 56 K at most, a 122-type compound ((Ba, K)Fe₂As₂ as an example, refer to FIG. 1B) having a ThCr₂Si₂ crystal structure which exhibits T_{c} of approximately 38 K at most, and an 11-type compound (Fe(Se, Te) as an example, refer to FIG. 1C) having an α-PbO crystal structure which exhibits T_{c} of approximately 15 K at most have been developed. In addition, in FIGS. 1A to 1C, Ln represents a lanthanoid element, Pn represents a pnictogen element such as P and As, Ae represents an alkali-earth metal element, and Ch represents a chalcogen element.

Among these materials, the 1111-type compound or the 122-type compound which has high T_{c} exhibits a high upper critical magnetic field (H_{c2}) comparable to that of the copper oxide superconductor. Accordingly, for application of the above-described compound to a wire material, an attempt has been made to manufacture a sheath wire material according to the PIT method and to manufacture a tape wire material in which a thin film of a superconducting layer is laminated according to a film forming method such as the PLD method.

Particularly, a 122-type compound has characteristics, which are appropriate for application in magnetic fields, such as having small anisotropy in the upper magnetic field (H_{c2}), and is capable of forming an epitaxial thin film with high quality relatively easily according to the PDL method. Accordingly, a method of manufacturing a thin film on a metal substrate having a biaxially oriented intermediate layer including the same IBAD-MgO layer as the Y-based copper oxide wire material has been attempted.

For example, in a Co-substituted BaFe₂As₂ (Ba122) thin film, as critical current density (J_{c}) in a self magnetic field at 4.2 K, a value equal to or higher than 1 MA/cm² has been reported (Katase et al., Applied Physics Letters, Vol. 98, 242510 (2011)).

In the above-described films, as shown in FIG. 11A, a layer-shaped defect 22 such as a crystal grain boundary and dislocation in a film thickness direction (a c-axis direction) of a superconducting layer 21, or a line-shaped defect 23 is present. Therefore, it is pointed out that a pinning effect weak with respect to an application of a magnetic field in the c-axis direction is present. However, J_{c} relatively rapidly decreases due to application of the magnetic field, and J_{c} is apt to be equal to or less than 0.1 MA/cm² at application of a magnetic field of 7 T.

Therefore, some iron-based superconducting materials having a magnetic flux pinning center, which improves J_{c} in a magnetic field, are reported. “Lee et al., Nature Materials, Vol. 9, 397 (2010)” and “Zhang et al., Applied Physics Letters, Vol. 98, 042509 (2011)” report an iron-based superconducting material in which a magnetic flux pinning center 25 is formed in a rod shape in the film thickness direction (c-axis direction) of a superconducting layer 24 formed from a 122-type compound as shown in FIG. 11B. More specifically, in a Co-substituted Ba122 (Ba(Fe, Co)₂As₂ thin film that is made to grow on an SrTiO₃ intermediate layer according to the PLD method, oxide impurity BaFeOx that becomes the magnetic flux pinning center is naturally formed. According to the above report, a high J_{c} equal to or more than 1 MA/cm² in a magnetic field of 7 T which is applied in parallel with the c-axis can be obtained.

However, the following problems are present in the aforementioned film. That is, in a case of applying a magnetic field in an a-axis direction and a b-axis direction, J_{c} is as small as ⅕ or less times J_{c} in a case of applying the magnetic field in the c-axis direction, and the minimum value of J_{c} when changing a magnetic field angle greatly decreases, thereby causing a problem for application to a superconducting magnet.

On the other hand, with regard to the Y-based copper oxide superconducting wire material, it is reported that the minimum value of J_{c} when changing a magnetic field angle can be improved by dispersing nanoparticles or nano-rods of oxide impurities such as BaZrO₃ and Y₂O₃ according to an MOD method or the PLD method (Maiorov et al., Nature Materials, Vol. 8, 398 (2009), and the like). However, with regard to the 122-type iron-based superconducting material that does not contain oxygen, a thin film is typically manufactured in ultra-high vacuum or high vacuum. Therefore, in an oxygen atmosphere, a problem such as deterioration in crystallinity of a thin film occurs, and thus it is not reported that the oxide nanoparticles are artificially dispersed.

A conventional 122-type iron-based superconducting material has a problem in that J_{c} rapidly decreases with respect to application of a magnetic field. In addition, even when a rod-shaped magnetic flux pinning center is formed in a film by using an oxide buffer layer (refer to FIG. 11B), J_{c} is improved with respect to application of the magnetic field in the c-axis direction, but there is a problem in that when the magnetic field is applied in directions (the a-axis direction and the b-axis direction) perpendicular to the c-axis, J_{c} is not improved in most cases and adversely decreases.

### SUMMARY OF THE INVENTION

An object of the invention is to provide an iron-based superconducting material in which a decrease in J_{c} is small with respect to application of a magnetic field in all directions and dependency of J_{c} on a magnetic field angle is small (that is, anisotropy is small), a superconducting layer using the iron-based superconducting material, and a wire material which includes the superconducting layer and which is capable of being used at a low temperature and in a high magnetic field.

To solve the above-described problems, according to a first aspect of the invention, an iron-based superconducting material is provided including an iron-based superconductor having a crystal structure of ThCr₂Si₂ and nanoparticles which are expressed by BaXO₃ (X represents one, two, or more kinds of elements selected from a group consisting of Zr, Sn, Hf, and Ti) and have a particle size of 30 nm or less. The nanoparticles are dispersed in a volume density of 1×10²¹m⁻³ or more.

In addition, in the iron-based superconducting material of the first aspect of the invention, the iron-based superconductor having the crystal structure of ThCr₂Si₂ may be AFe₂₊ₓ(As_{1-y}, P_{y})_{2-z}(A represents one or two kinds of elements selected from a group consisting of Ba and Sr, −0.2≦x≦0.2, 0.2≦y≦0.45, and 0≦z≦0.2).

In addition, in the iron-based superconducting material of the first aspect of the invention, the iron-based superconductor having the crystal structure of ThCr₂Si₂ may be (A_{1-α}, K_{α})Fe_{2+β}As_{2-γ}(A represents one or two kinds of elements selected from a group consisting of Ba and Sr, 0.25≦α≦0.65, −0.2≦β3≦0.2, and 0≦γ≦0.2).

In addition, in the iron-based superconducting material of the first aspect of the invention, the iron-based superconductor having the crystal structure of ThCr₂Si₂ may be A(Fe₁₋ₚ, Coₚ)_{2+q}As₂₋ᵣ (A represents one or two kinds of elements selected from a group consisting of Ba and Sr, 0.06≦p≦0.13, −0.2≦q≦0.2, and 0≦r≦0.2).

In addition, in the iron-based superconducting material of the first aspect of the invention, the particle size of the nanoparticles may be 5 to 15 nm.

In addition, in the iron-based superconducting material of the first aspect of the invention, the nanoparticles may be dispersed in a volume density of 1×10²²m⁻³ to 6×10²³m⁻³

In addition, according to a second aspect of the invention, an iron-based superconducting layer constituted by the iron-based superconducting material according to the first aspect is provided.

In addition, according to a third aspect of the invention, an iron-based superconducting tape wire material including an iron-based superconducting layer constituted by the iron-based superconducting material according to the first aspect is provided.

In addition, according to a fourth aspect of the invention, an iron-based superconducting tape wire material including the iron-based superconducting material according to the first aspect which is filled in a metal sheath is provided.

In the iron-based superconducting material according to the first aspect of the invention, nanoparticles which is expressed by BaXO₃ (X represents one, two, or more kinds of elements selected from a group consisting of Zr, Sn, Hf, and Ti) and which has a particle size of 30 nm or less are contained in an iron-based superconductor having a crystal structure of ThCr₂Si₂, and thus even when a magnetic field is applied, it is possible to suppress a decrease in a critical current density (J_{c}). Furthermore, the nanoparticles having the particle size of 30 nm or less are dispersed in a volume density of 1×10²¹m⁻³ or more, and thus even when a magnetic field is applied in directions (an a-axis direction and a b-axis direction) perpendicular to a c-axis, it is possible to suppress a decrease in J_{c}. That is, it is possible to provide an iron-based superconducting material in which dependency of J_{c} on a magnetic field angle is small, a superconducting layer using the iron-based superconducting material, and a wire material which includes the superconducting layer and which is capable of being used at a low temperature and in a high magnetic field.

### BRIEF DESCRIPTION OF THE DRAWINGS

FIG. 1A is a view illustrating a crystal structure of a representative iron-based superconductor.

FIG. 1B is a view illustrating a crystal structure of a representative iron-based superconductor.

FIG. 1C is a view illustrating a crystal structure of a representative iron-based superconductor.

FIG. 2 is a schematic view illustrating an embodiment of an iron-based superconducting tape wire material according to the invention, and shows a structure in which an iron-based superconducting layer formed from an iron-based superconducting material is formed on a tape base material.

FIG. 3 is a schematic view illustrating an embodiment of an iron-based superconducting material according to the invention, and shows a situation in which nanoparticles are dispersed in a thin film of the iron-based superconductor.

FIG. 4 is a schematic view illustrating an embodiment of an iron-based superconducting wire material according to the invention, and shows a structure in which the iron-based superconducting material is filled in a metal sheath.

FIG. 5A is a view illustrating an X-ray diffraction pattern in Examples and Comparative Examples.

FIG. 5B is a view illustrating a Zr-element distribution state in Examples, which is obtained through observation using a transmission electron microscope (TEM).

FIG. 6 is a view illustrating a histogram of a particle size of the nanoparticles and the number of the nanoparticles observed in a measurement area in Examples.

FIG. 7 is a view illustrating magnetic field dependency of a critical current density in Examples.

FIG. 8 is a view illustrating a relationship between a magnetic flux density and a maximum pinning force in Examples.

FIG. 9 is a view illustrating a magnetic field angle dependency of the critical current density in Examples.

FIG. 10A is a view illustrating a relationship between magnetic flux density and an effect of enhancing a critical current density by dispersed nanoparticles in Examples.

FIG. 10B is a view illustrating the relationship between the volume density of nanoparticles and magnetic field where maximum enhancement of the critical current density is achieved in Examples.

FIG. 11A is a schematic view illustrating a conventional iron-based superconducting material, and shows an iron-based superconducting layer having a layer-shaped or line-shaped defect.

FIG. 11B is a schematic view illustrating a conventional iron-based superconducting material, and shows an iron-based superconducting layer in which a magnetic flux pinning center is formed in a rod shape.

### DETAILED DESCRIPTION OF THE INVENTION

Hereinafter, an embodiment of an iron-based superconducting material according to the invention will be described with reference to the attached drawings. In addition, in the drawings which are used in the following description, as a matter of convenience, characteristic portions may be enlarged for easy understanding, and dimension ratios, and the like of components are not intended to be the same as actual dimension ratios, and the like. In addition, the invention is not limited to the following embodiment.

Iron-Based Superconducting Tape Wire Material

FIG. 2 shows an iron-based superconducting tape wire material 1 according to an embodiment of the invention. In the iron-based superconducting tape wire material 1, an intermediate layer 8, an iron-based superconducting layer (iron-based superconducting material) 6, and a stabilization layer 7 are laminated on a main surface (surface) of a tape-shaped base material 2. In addition, the intermediate layer 8 is constituted by a bed layer 3, a first orientation layer 4, and a second orientation layer 5.

The base material 2 may be a member which is capable of being used as a typical superconducting wire material, and it is preferable that the base material 2 have a long flexible tape-shape. In addition, as a material that is used for the base material 2, a metal-containing material, which has high mechanical strength and heat resistance and which is easy to be processed into a wire material, is preferable.

As a commercially available product, Hastelloy (product name, manufactured by Haynes International, Inc.) is very suitable, and any kind of Hastelloy B, Hastelloy C, Hastelloy G, Hastelloy N, Hastelloy W, and the like in which component amounts of molybdenum (Mo), chromium (Cr), iron (Fe), cobalt (Co), and the like are different may be used. In addition, an oriented Ni—W alloy tape base material, in which an aggregate structure is introduced in a nickel alloy, may be used as the base material 2.

The intermediate layer 8 has a function of controlling the crystal orientation of the iron-based superconducting layer 6 and preventing diffusion of metal elements in the base material 2 to an iron-based superconducting layer 6. Furthermore, the intermediate layer 8 functions as a buffer layer that releases a difference in physical characteristics (a coefficient of thermal expansion, a lattice constant, and the like) between the base material 2 and the iron-based superconducting layer 6. A material of the intermediate layer 8, a metal oxide, which has physical characteristics showing an intermediate value between the base material 2 and the iron-based superconducting layer 6, is preferable.

The intermediate layer 8 of this embodiment is constituted by the bed layer 3, the first orientation layer 4, and the second orientation layer 5, but the invention is not limited to this configuration. It is possible to employ a configuration in which a diffusion prevention layer (formed from silicon nitride (Si₃N₄), alumina (Al₂O₃), and the like as an example) that prevents constituent elements of the base material 2 is formed between the base material 2 and the bed layer 3.

The bed layer 3 that constitutes the intermediate layer 8 has high heat resistance and has a function of reducing interface reactivity, and thus the bed layer 3 is used to obtain an orientation of a film formed on the bed layer 3. The bed layer 3 is constituted by Y₂O₃, Er₂O₃, CeO₂, Dy₂O₃, Er₂O₃, Eu₂O₃, Ho₂O₃, La₂O₃, and the like. The bed layer 3 is formed according to a film forming method such as a sputtering method. In addition, the bed layer 3 may be omitted.

The first orientation layer 4 is formed from a biaxially orienting material to control crystal orientation of the second orientation layer 5 that is located on the first orientation layer 4. Specific examples of a material of the first orientation layer 4 include a metal oxide such as MgO.

When the first orientation layer 4 is formed with excellent biaxial orientation according to an iron beam assisted deposition (IBAD) method, it is possible to make crystal orientation of the second orientation layer 5 excellent, and thus crystal orientation of the iron-based superconducting layer 6 that is formed on the second orientation layer 5 may be excellent. As a result, excellent superconducting characteristics can be exhibited.

An IBAD-MgO layer formed from MgO according to the IBAD method is applied to the first orientation layer 4 of this embodiment. Accordingly, in the following description, the first orientation layer 4 is assumed as the IBAD-MgO layer unless otherwise stated.

The second orientation layer 5 is constituted by a material which forms a film on a surface of the above-described first orientation layer (IBAD-MgO layer) 4 and in which crystal grains can self-orient in an in-plane direction. An MgO film formed by sputtering and the like of MgO is applicable to the second orientation layer 5. When the MgO film is formed by the sputtering and the like, the MgO film may be formed at a fast film formation rate, and thus it is possible to obtain excellent crystal orientation. The second orientation film 5 can be formed in a thickness range of 50 to 500 nm.

The sputtered MgO layer which is formed by sputtering and is formed from MgO is applied to the second orientation layer 5 of this embodiment. Accordingly, in the following description, the second orientation layer 5 is assumed as the sputtered-MgO layer unless otherwise stated.

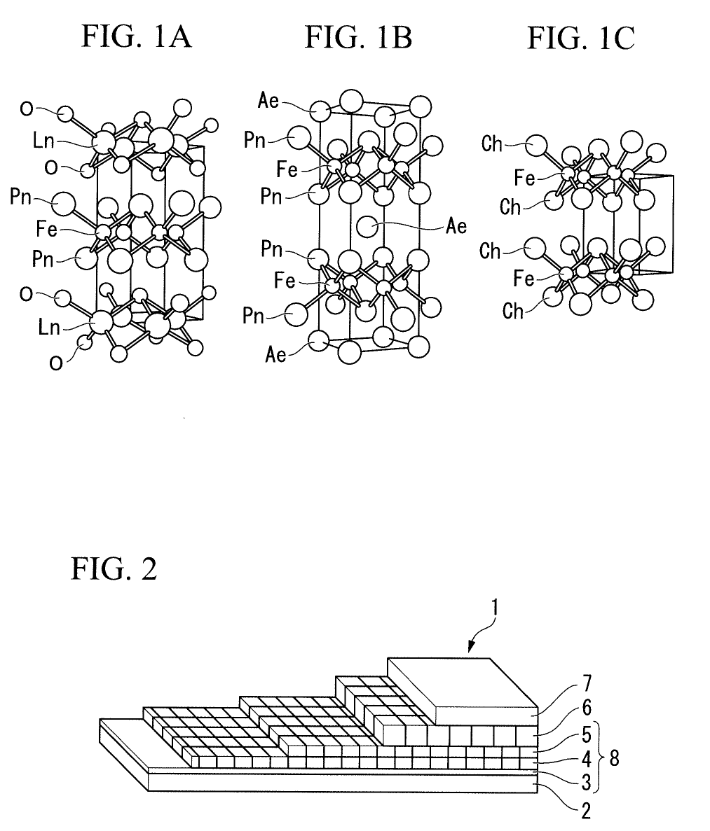

With regard to the iron-based superconducting layer 6 that is constituted by the iron-based superconducting material of this embodiment, nanoparticles which are formed from BaXO₃ (X represents one, two, or more kinds of elements selected from a group consisting of Zr, Sn, Hf, and Ti) and have a particle size of 30 nm or less are dispersed in a thin film of an iron-based superconductor (122-type compound) having a ThCr₂Si₂ crystal structure as shown in FIG. 1B in a volume density of 1×10²¹m⁻³ or more.

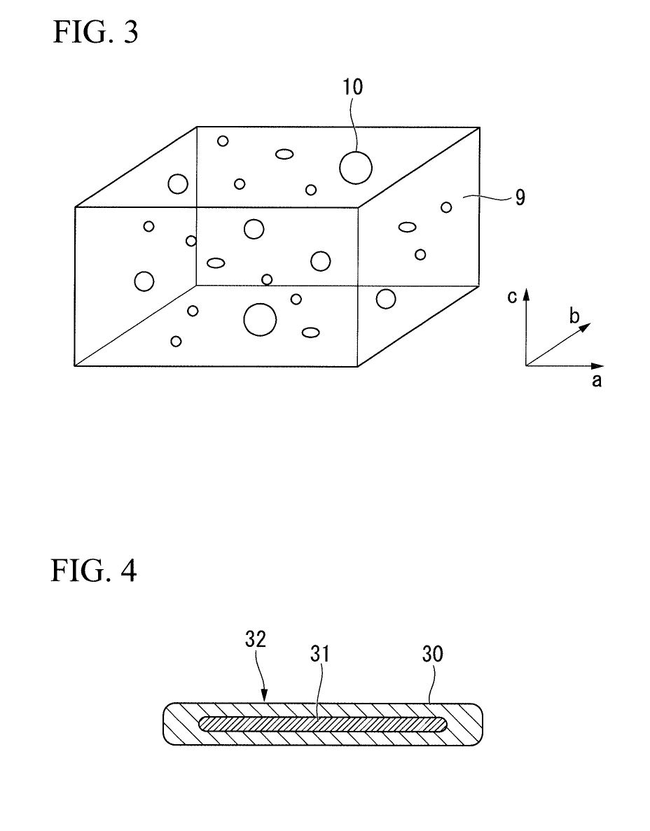

FIG. 3 schematically shows an internal structure of the iron-based superconducting layer 6 of this embodiment. As shown in FIG. 3, with regard to the iron-based superconducting layer, nanoparticles 10 are dispersed in a thin film 9 of an iron-based superconductor.

The nanoparticles 10 are formed from BaXO₃ (X represents one, two, or more kinds of elements selected from a group consisting of Zr, Sn, Hf, and Ti), and have a particle size of 30 nm or less, and more preferably 5 to 15 nm.

In addition, the nanoparticles 10 are dispersed in the thin film 9 of the iron-based superconductor in a volume density of 1×10²¹m⁻³ or more, and more preferably a volume density of 1×10²²m⁻³ to 6×10²³m⁻³

In addition, even when the particle size of BaXO₃ exceeds 30 nm, the nanoparticles 10 having a particle size of 30 nm or less may effectively function as the magnetic flux pinning center as long as the nanoparticles 10 having a particle size of 30 nm or less are dispersed in the above-described volume density range.

Conventionally, uniform dispersion of an oxide in the thin film 9 of the iron-based superconductor, which does not contain oxygen, is considered to be difficult. However, the present inventors have found that a perovskite structure oxide (BaXO₃ (X represents one, two, or more kinds of elements selected from a group consisting of Zr, Sn, Hf, and Ti)) constituted by Ba and one, two, or more kinds of elements selected from a group consisting of Zr, Sn, Hf, and Ti, which have a strong binding force with oxygen, can be stably present as nanoparticles in a matrix of a 122-type compound that is an iron-based superconductor not containing oxygen. That is, when BaXO₃ as the nanoparticles 10 is dispersed in the thin film 9 of the iron-based superconductor, BaXO₃ is allowed to function as the magnetic flux pinning center. Accordingly, even when a magnetic field is applied, it is possible to suppress a decrease in a critical current density (J_{c}) of the iron-based superconducting material.

In addition, in oxides relating to BaXO₃, particularly, BaZrO₃ (BZO), BaHfO₃ (BHO), and BaTiO₃ (BTO) become stable in the thin film 9 of the iron-based superconductor, and thus an effect as the magnetic flux pinning center is high. Accordingly, these oxides are appropriately employed.

However, a superconducting coherence length ξ of the 122-type iron-based superconductor having the crystal structure of ThCr₂Si₂ in an a-axis direction and a b-axis direction is approximately 2.5 nm at a low temperature (for example, 5 K), and approximately 4 nm at 15 to 20 K.

When the particle size d of the nanoparticles 10 dispersed in the thin film 9 of the iron-based superconductor is not significantly larger than the superconducting coherence length ξ, the nanoparticles 10 can function as an effective magnetic flux pinning center.

More specifically, when d/(2ξ) that is a ratio of the particle size d of the nanoparticles 10 to two times the superconducting coherence length ξ is 1 to 4, the nanoparticles 10 function as the magnetic flux pinning center. That is, it is preferable that the particle size d of the nanoparticles 10 satisfy a relationship of 2ξ≦d≦8ξ.

Accordingly, when considering that the superconducting coherence length ξ of the 122-type iron-based superconductor in the a-axis direction and the b-axis direction is approximately 2.5 to 4 nm at 5 K to 20 K, if the particle size d of the nanoparticles 10 is approximately 5 to 30 nm, the nanoparticles 10 function as the magnetic flux pinning center.

In addition, d/(2ξ) that is the ratio of the particle size d of the nanoparticles 10 to two times the superconducting coherence length ξ is more preferably 3 or less at a low temperature (for example 5 K). When d/(2ξ) is 3 or less, a strong magnetic flux pinning force can be obtained in a wide temperature range.

That is, it is more preferable that the particle size d of the nanoparticles 10 satisfy a relationship of 2ξ≦d≦6ξ. Since the superconducting coherence length ξ at a low temperature is approximately 2.5 nm, the particle size d of the nanoparticles 10 is more preferably 15 nm or less.

When the nanoparticles 10 are uniformly dispersed in the thin film 9 of the iron-based superconductor, it is possible to allow the nanoparticles 10 to function as the magnetic flux pinning center against magnetic fields applied in all directions.

Even when the volume density of the nanoparticles 10 is as little as 1×10²¹m⁻³ in terms of a dispersion amount, it is possible to suppress a decrease in J_{c} inside a magnetic field. However, it is more preferable that the nanoparticles 10 be dispersed in a volume density of 1×10²²m⁻³ to 6×10²³m⁻³. When the dispersion is performed in the volume density, an average distance between the nanoparticles 10 can be approximately 20 to 30 nm, and thus it is possible to efficiently pin total magnetic fluxes against application of a magnetic field of several T.

In a case where the nanoparticles 10 are dispersed in a volume density exceeding 6×10²³m⁻³, there is a concern that T_{c} decreases, or a path through which a current flows is blocked, and thus J_{c} decreases. Accordingly, this case is not preferable.

In addition, as the 122-type iron-based superconductor that is applied to the superconducting material of the invention, among 122-type superconductors, it is preferable to use a superconductor which has high T_{c} of 25 K or more and in which a main phase is any one of AFe₂(As, P)₂, (A, K)Fe₂As₂, and A(Fe, Co)₂As₂ (A represents one or two kinds of elements selected from a group consisting of Ba and Sr).

More specifically, it is preferable that a combination of a crystal structure of the superconductor be AFe₂₊ₓ(As_{1-y}, P_{y})_{2-z} (−0.2≦x≦0.2, 0.2≦y≦0.45, and 0≦z≦0.2), (A_{1-α}, K_{α})Fe_{2+β}As_{2-γ}(0.25≦α≦0.65, −0.2<3<0.2, and 0≦γ≦0.2), or A(Fe₁₋ₚ, Coₚ)_{2+q}As₂-r (0.06≦p≦0.13, −0.2≦q≦0.2, and 0≦r≦0.2). When the crystal structure has the compositions, it is possible to form a superconducting material that stably exhibits superconducting characteristics.

The iron-based superconducting layer 6 in which the nanoparticles 10 are uniformly dispersed in the thin film 9 of the 122-type iron-based superconductor can be formed by a pulsed laser deposition (PLD) method. The PLD method is a lamination method of depositing a jet flow of constituent particles, which are knocked out from a target by laser light irradiation, on an object. Accordingly, in this embodiment, the jet flow of the target is deposited toward the intermediate layer 8 on the main surface of the base material 2 to form the iron-based superconducting layer 6 on the intermediate layer 8.

To form the iron-based superconducting layer 6, a sintered body of a material, which has the same or nearly the same composition as the iron-based superconducting layer 6 to be formed or which contains a large amount of components that are likely to escape during film formation, may be used as the target.

In a case of forming the iron-based superconducting layer 6 according to the PLD method, a material (BaXO₃) that becomes a source of the nanoparticles 10 is mixed in the target for film formation in combination with a constituent material of the thin film 9 of the iron-based superconductor, and thus the nanoparticles 10 can be introduced simultaneously with crystal growth of the iron-based superconducting layer 6.

In the iron-based superconducting tape wire material 1, the stabilization layer 7 is laminated on the iron-based superconducting layer 6. The stabilization layer 7 has a function of bypassing an overcurrent that occurs during a trouble, a function of suppressing a chemical reaction that occurs between the iron-based superconducting layer 6 and a layer that is provided on an upper surface in relation to the iron-based superconducting layer 6, and the like.

In addition, in this embodiment, a description has been made with respect to the iron-based superconducting tape wire material 1 in which the iron-based superconducting layer 6 is formed on the tape-shaped base material 2 through the intermediate layer 8 as shown in FIG. 2. However, the iron-based superconducting material according to the embodiment of the invention is applicable to an iron-based superconducting wire material 32 in which an iron-based superconducting wire material 31 is embedded inside a sheath 30 constituted by a stabilizing material such as Ag as shown in FIG. 4.

That is, as the iron-based superconducting wire material 31 filled inside the sheath 30, when using a material obtained by dispersing nanoparticles which are formed from BaXO₃ (X represents one, two, or more kinds of elements selected from a group consisting of Zr, Sn, Hf, and Ti) and have a particle size of 30 nm or less in the iron-based superconductor (122-type superconductor) having a crystal structure of ThCr₂Si₂ in a volume density of 1×10²¹m⁻³ or more, it is possible to obtain the same effect as the above-described embodiment.

### EXAMPLES

Hereinafter, the invention will be described in more detail with reference to examples, but the invention is not limited to the examples.

### Test Example 1

An iron-based superconducting layer of 80 nm was formed on an MgO (100) single-crystal substrate according to the PLD method. A secondary-harmonic Nd:YAG laser (wavelength: 532 nm) was used as a laser light source, energy density of the laser light on a target was set to 10 J/cm², and a repetitive frequency was set to 10 Hz. In addition, a substrate temperature was set to 800° C. during film formation.

As Example A, an iron-based superconducting wire material, in which the iron-based superconducting layer was formed using a target obtained by containing 1 mol % of BaZrO₃ (BZO) in BaFe₂(As_{0.67}P_{0.33})₂, was prepared.

As Example B, an iron-based superconducting wire material, in which the iron-based superconducting layer was formed using a target obtained by containing 3 mol % of BaZrO₃ (BZO) in BaFe₂(As_{0.67}P_{0.33})₂, was prepared.

As Comparative Example A, an iron-based superconducting wire material, in which the iron-based superconducting layer was formed using a target not containing BZO, was prepared.

In addition, BaFe₂(As_{0.67}P_{0.33})₂ is a P-substituted Ba122-type iron-based superconductor, and is described as “Ba122:P” in the following description and drawings.

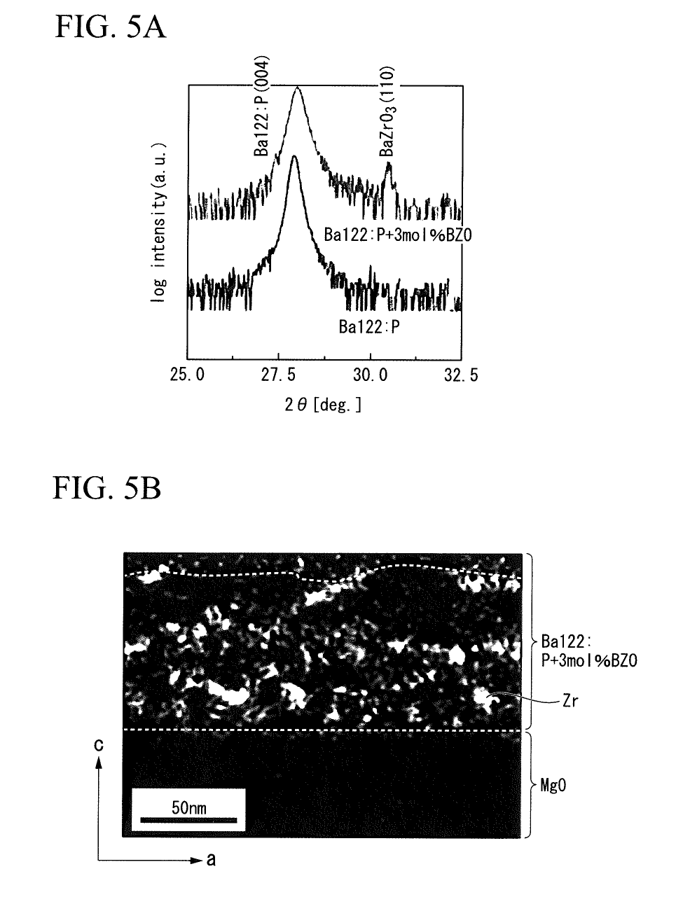

FIG. 5A shows results obtained by performing X-ray diffraction analysis with respect to the iron-based superconducting layers of Example B (Ba122:P+3 mol % of BZO) and Comparative Example A (Ba122:P).

In an X-ray diffraction analysis result of Example B which is shown on an upper side of FIG. 5A, a diffraction peak of BaZrO₃ (BZO) was observed together with a c-axis orientation peak of Ba122:P. That is, it was confirmed that particles of BZO were formed inside the iron-based superconducting layer of Example B.

On the other hand, in an X-ray diffraction analysis result of Comparative Example A which is shown on a lower side of FIG. 5A, only the c-axis orientation peak of Ba122:P was observed.

In addition, when comparing the c-axis orientation peaks of Ba122:P of Example B and Comparative Example A, the c-axis orientation peak of Example B was not decreased significantly in comparison to Comparative Example A. That is, with regard to an orientation degree of Example B, an additional significant deterioration in an out-of-plane and in-plane orientation degree was not observed.

Next, FIG. 5B shows a Zr-element distribution state obtained by observing a cross-section of Example B (Ba122:P+3 mol % of BZO) using a transmission electron microscope (TEM). In addition, in FIG. 5B, a white portion in the iron-based superconducting layer (Ba122:P+3 mol % of BZO) represents Zr.

In addition, in a case (not shown) of observing a distribution of Fe elements or As elements using the TEM on the same cross-section as the cross-section shown in the FIG. 5B, an image inverted from the distribution of Zr elements was observed. From this observation, it was confirmed that BZO containing Zr elements were dispersed inside the superconductor Ba122:P constituted by Fe elements and As elements.

Element mapping of Zr was performed by TEM observation to measure a particle size and a volume density of the BZO nanoparticles contained in the iron-based superconducting layer of Example B. From the element mapping, it was confirmed that randomly oriented BZO nanoparticles having an average particle size of 8 nm were dispersed in the iron-based superconducting layer of Example B in a volume density of 6.7×10²²m⁻³. In addition, it was confirmed that the BZO nanoparticles having a particle size of 5 to 15 nm, which are highly effective as the magnetic flux pinning center, were dispersed in a volume density of 4.0×10²²m⁻³

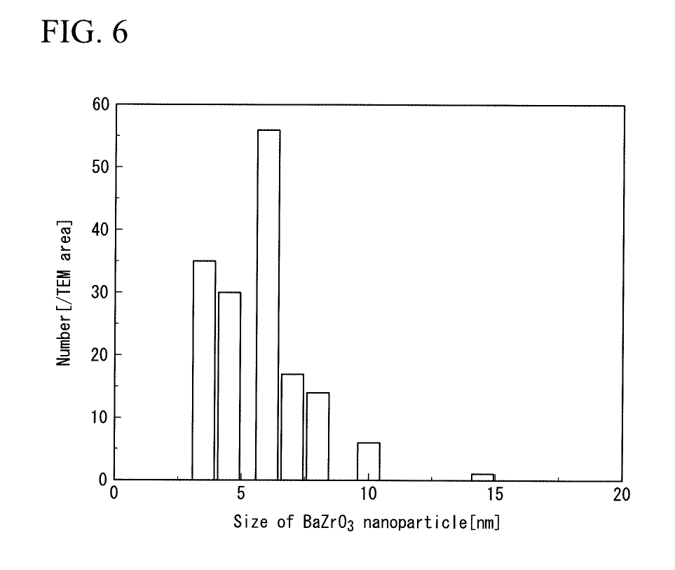

FIG. 6 shows a histogram of the particle size of the BZO nanoparticles and the number of the BZO nanoparticles observed in a measurement area. As shown in FIG. 6, the BZO nanoparticles are distributed in a range of 3 to 15 nm.

A cross-section of Example A (Ba122:P+1 mol % of BZO) was observed using the TEM in the same sequence as described above and element mapping was performed.

It was confirmed that randomly oriented BZO nanoparticles having an average particle size of 8 nm were dispersed in the iron-based superconducting layer of Example A in a volume density of 2.5×10²²m⁻³.

In addition, T_{c}zero (temperature when a resistance value becomes zero) of the iron-based superconducting layer of Example B (Ba122:P+3 mol % of BZO) was 26.5 K, and a decrease in T_{c} due to introduction of the nanoparticles formed from BZO was hardly observed.

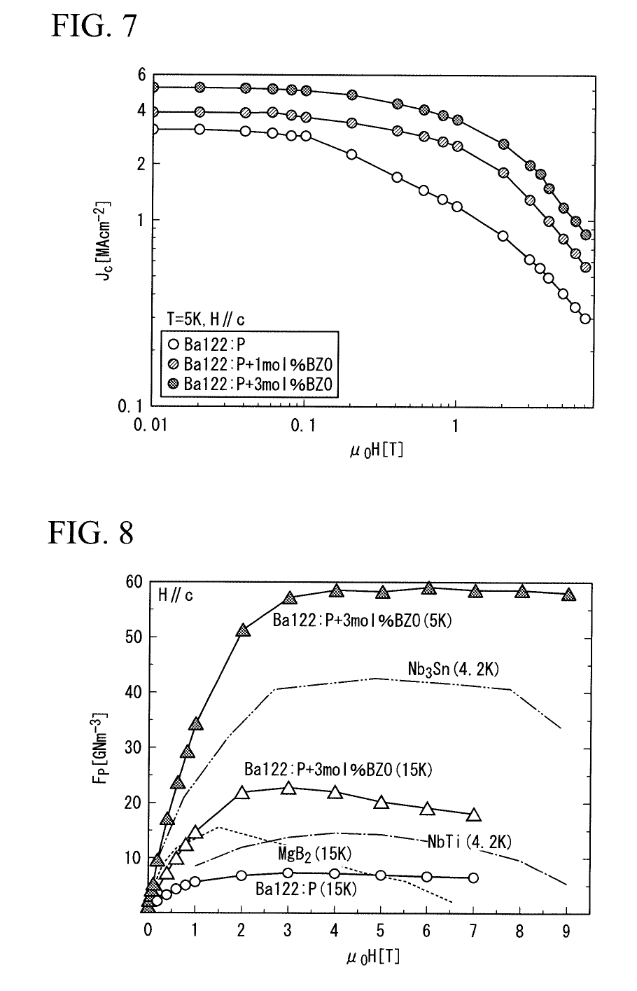

FIG. 7 shows measurement results of magnetic field dependency of J_{c} at 5 K with respect to the iron-based superconducting layers of Example A (Ba122:P+1 mol % of BZO), Example B (Ba122:P+3 mol % of BZO), and Comparative Example A (Ba122:P). In addition, a magnetic field application direction was a c-axis direction.

In FIG. 7, the horizontal axis shows a magnetic flux density (μ₀H) of a magnetic field applied in the c-axis direction, and the vertical axis shows a critical current density J_{c}.

When comparing measurement results of Example A, Example B, and Comparative Example A, in a magnetic field application range of 7 T or less, it was confirmed that when the nanoparticles formed from BZO were introduced, a decrease in J_{c} of the iron-based superconducting layer due to magnetic field application in the c-axis direction was suppressed. In addition, the effect of suppressing the decrease in J_{c} of the iron-based superconducting layer of Example B was higher in comparison to the iron-based superconducting layer of Example A. This effect is considered to be because BZO nanoparticles were dispersed in the iron-based superconducting layer of Example A in a volume density of 2.5×10²²m⁻³, but the BZO nanoparticles were dispersed in the iron-based superconducting layer of Example B in a volume density of 6.7×10²²m⁻³, and thus the nanoparticles were dispersed in a high density and the effect of suppressing the decrease in J_{c} increased.

In addition, J of the iron-based superconducting layer of Example B (Ba122:P+3 mol % of BZO) at 5 K and 7 T was approximately 1 MA/cm², and this value was approximately three times that of the iron-based superconducting layer of Comparative Example A.

Furthermore, from the measurement results shown in FIG. 7, the maximum pinning force (Fₚ) serving as a reference of magnetic flux pinning strength was assumed on the basis of the following formula.

Fₚ=J_{c}×μ₀H [Formula I]

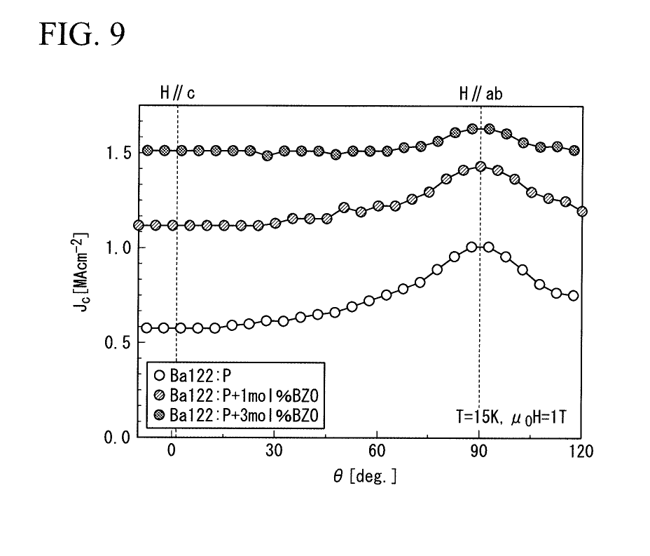

FIG. 8 shows a relationship between the magnetic flux density (μ₀H) of a magnetic field applied in the c-axis direction and the maximum pinning force (Fₚ), which was derived from the above-described formula. In addition, FIG. 8 shows a relationship between the magnetic flux density (μ₀H) of a magnetic field and the maximum pinning force (Fₚ) in a case of applying the magnetic field to a wire material formed from Nb₃Sn, NbTi, and MgB₂ that are metal-based superconducting materials in the c-axis direction.

In addition, Nb₃Sn and NbTi show measurement values at 4.2 K, and MgB₂ shows measurement values at 15 K.

From these results, in the iron-based superconducting layer of Example B (Ba122:P+3 mol % of BZO), it could be seen that approximately 60 GN/m³ of pinning force was obtained in a case of applying a magnetic field of 3 T to 9 T in the c-axis direction. It could be seen that this value was a pinning force exceeding the value of the maximum pinning force of the Nb₃Sn wire material (4.2 K) by approximately 50%.

In addition, it could be seen that the pinning force in the iron-based superconducting layer of Example A (Ba122:P+1 mol % of BZO) was smaller in comparison to Example B, but the pinning force was larger in comparison to Comparative Example A.

As shown in FIG. 8, it could be seen that even in a case of performing the above-described test at 15 K, a pinning force exceeding the maximum pinning force of the NbTi wire material (4.2 K) and the MgB₂ wire material (15 K) was obtained.

FIG. 9 shows measurement results of the magnetic field angle dependency of J_{c} at a temperature of 15 K and a magnetic field of 1T with respect to the iron-based superconducting layers of Example A (Ba122:P+1 mol % of BZO), Example B (Ba122:P+3 mol % of BZO), and Comparative Example A (Ba122:P). In FIG. 9, the horizontal axis shows an angle (θ) of a magnetic field that is applied, and the vertical axis shows the critical current density J_{c}. In addition, in the angle (θ) of the magnetic field that is applied, the c-axis direction is set as 0°, and 90° represents the a-axis direction or the b-axis direction.

When referring to the measurement result of the iron-based superconducting layer of Comparative Example A, in a case of applying the magnetic field in the c-axis direction (0°), J_{c} becomes the minimum, and in a case of applying the magnetic field in a direction (the a-axis direction and the b-axis direction, 90°) perpendicular to the c-axis, Jc becomes the maximum. In addition, a ratio of J_{c} in a case of applying a magnetic field in the c-axis direction and J_{c} in a case of applying in the a-axis direction and b-axis direction becomes approximately the same as anisotropy of an upper critical magnetic field and is 1.6.

In addition, when referring to the measurement results of the iron-based superconducting layers of Example A and Example B, similar to the measurement result of the iron-based superconducting layer of Comparative Example A, in a case of applying the magnetic field in the c-axis direction, J_{c} becomes the minimum, and in a case of applying the magnetic field in a direction perpendicular to the c-axis direction, J_{c} becomes the maximum. On the other hand, when comparing the measurement result of Comparative Example A and the measurement results of Example A and Example B, it can be confirmed that a decrease in J_{c} due to introduction of the nanoparticles formed from BZO is suppressed at all magnetic field angles (θ). In addition, the iron-based superconducting layer of Example B had a higher effect of suppressing the decrease in J_{c} in comparison to the iron-based superconducting layer of Example A. This effect is considered to be caused by a difference in a volume density of the BZO nanoparticles between the iron-based superconducting layers of Example A and Example B. Furthermore, in Example B, a ratio between J_{c} in a case of applying the magnetic field in the c-axis direction and J_{c} in a case of applying the magnetic field in the a-axis direction and the b-axis direction was 1.1, and thus it was confirmed that this ratio greatly decreased in comparison to 1.55 that is the ratio of the upper critical magnetic field.

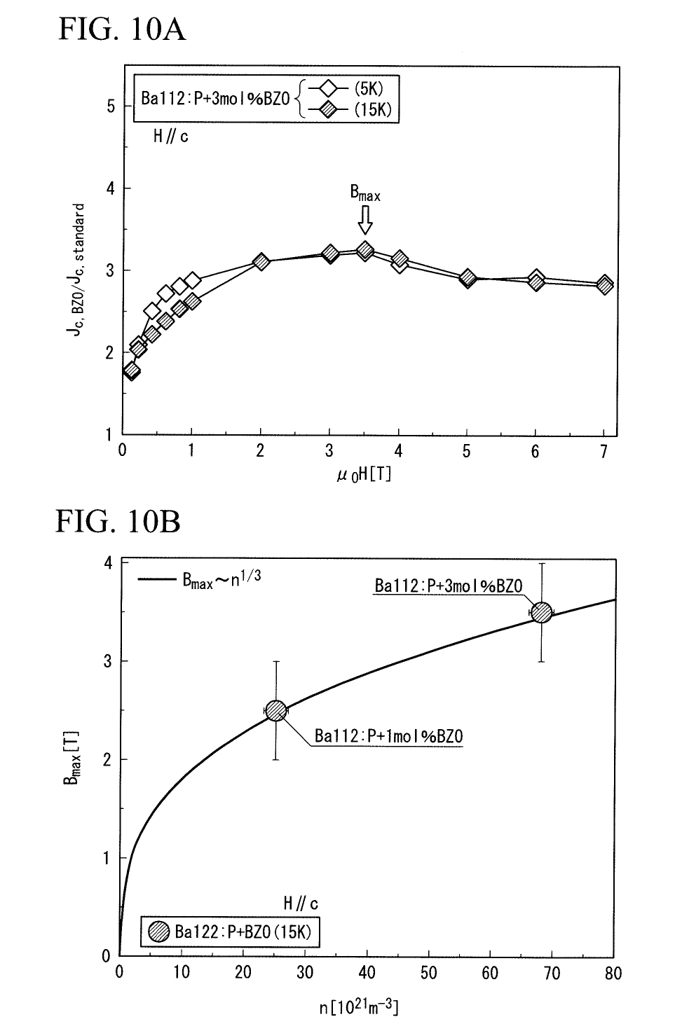

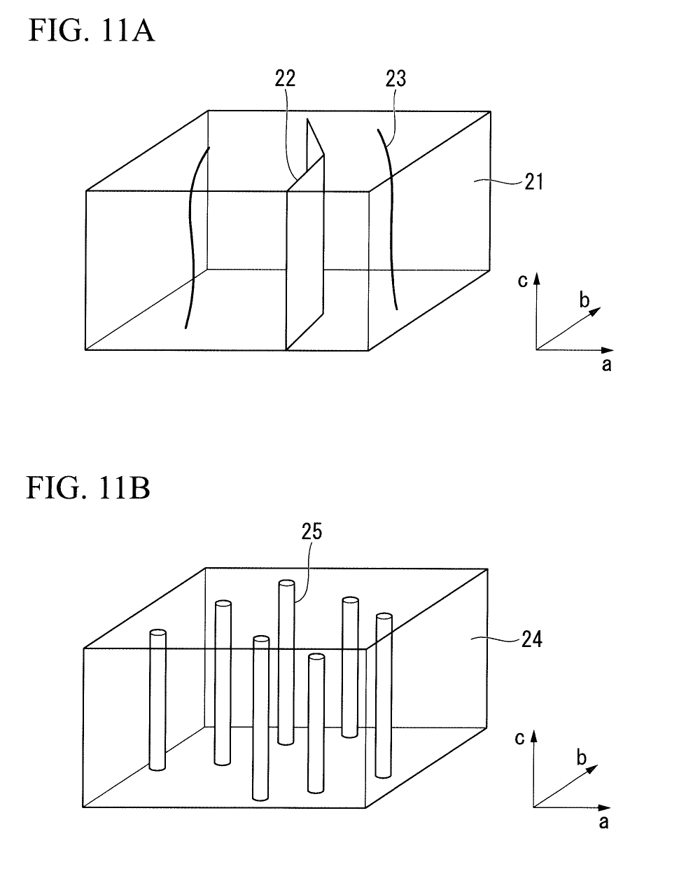

FIGS. 10A and 10B show views illustrating a relationship between a magnetic flux pinning effect (that is, an effect of suppressing a decrease in a critical current density) of the iron-based superconducting layer and a dispersion amount of the BZO nanoparticles.

FIG. 10A shows a view obtained by plotting measurement results of the magnetic field dependency of J_{c} at 5 K and 15 K with respect to the iron-based superconducting layer of Example B (Ba122:P+3 mol % of BZO). However, in FIG. 10A, the horizontal axis shows the magnetic flux density (μ₀H) of the magnetic field applied in the c-axis direction, and the vertical axis shows a ratio (J_{c, BZO}/J_{c, standard}) of J_{c, BZO} of the iron-based superconducting layer of Example B to the critical current density J_{c, standard} of the iron-based superconducting layer of Comparative Example A (not containing BZO particles).

As shown in FIG. 10A, it can be seen that in a case of applying a magnetic field of approximately 3.5 T_{c} the effect as the magnetic flux pinning center increases in the iron-based superconducting layer (Example B) using a target that contains 3 mol % of BZO. In this manner, the magnetic flux density in the c-axis direction which has the highest effect as the magnetic flux pinning center is called Bₘₐₓ.

When plotting the same drawing as FIG. 10A with respect to the iron-based superconducting layer of Example A (Ba122:P+1 mol % of BZO), the magnetic flux density Bₘₐₓ in the c-axis direction, in which the effect as the magnetic flux pinning center was the highest at 15 K, was approximately 2.5 T.

FIG. 10B shows a relationship between the volume density of the BZO nanoparticles dispersed in the iron-based superconducting layers of Example A and Example B, and Bₘₐₓ at 15 K.

As shown in FIG. 10B, it can be seen that when increasing the volume density of the BZO nanoparticles dispersed in the iron-based superconducting layer, the magnetic field (that is, the magnetic flux density Bₘₐₓ) in the c-axis direction, in which the effect as the magnetic flux pinning center is the highest, also increases. That is, when increasing the volume density of the BZO nanoparticles that are dispersed, it is possible to increase the effect as the magnetic flux pinning center.

In addition, in a rare-earth element-based copper oxide superconducting material (for example, an Y-based copper oxide superconducting material), it is known that the effect as the magnetic flux pinning center due to the nanoparticles of oxide impurities increases in proportion to volume density of the nanoparticles of oxide impurities to the power of ½ or ⅓.

In FIG. 10B, from the same theoretical basis, it is considered that the magnetic flux pinning effect increases in proportion to volume density to the power of ⅓.

Next, a plurality of samples in which the composition of the iron-based superconducting layer was different in each case were prepared, and the composition of constituent elements of BaFe₂(As, P)₂ was changed in various manners, and then T_{c} of the iron-based superconducting layer or J_{c} in a magnetic field was measured.

In addition, the same target as the above-described target was used, and film forming conditions according to the PLD method were changed to change the composition of constituent element in various manners. In addition, the composition of the iron-based superconducting layer that was prepared was analyzed by electron probe microanalyzer (EPMA).

From the analysis, when a composition ratio between Ba, Fe, and As or P is a stoichiometric composition of 1:2:2, and the composition of Fe deviates in a range of ±10% and the composition of As or P deviates in a range of −10 to 0% on the basis of Ba, it was found that T_{c} of the iron-based superconducting layer or J_{c} in a magnetic field does not greatly vary. That is, in a case where the composition of the iron-based superconducting layer is expressed as BaFe₂₊ₓ(As, P)_{2-z}, when x and z satisfy relationships of −0.2≦x≦0.2 and 0≦z≦0.2, it was found that T_{c} of the iron-based superconducting layer or J_{c} in a magnetic field does not greatly vary.

In addition, improvement of J_{c} in the same magnetic field due to introduction of BZO nanoparticles, or an effect of reducing anisotropy in J_{c} due to a magnetic field direction was observed.

### Test Example 2

Next, only the composition of the target was changed in comparison to Test Example 1 to prepare iron-based superconducting wire materials of Example C, Example D, and Example E.

As Example C, an iron-based superconducting wire material, in which the iron-based superconducting layer was formed using a target obtained by containing 5 mol % of BaZrO₃ (BZO) in BaFe₂(As_{0.67}P_{0.33})₂, was prepared.

As Example D, an iron-based superconducting wire material, in which the iron-based superconducting layer was formed using a target obtained by containing 10 mol % of BaZrO₃ (BZO) in BaFe₂(As_{0.67}P_{0.33})₂, was prepared.

As Example E, an iron-based superconducting wire material, in which the iron-based superconducting layer was formed using a target obtained by containing 15 mol % of BaZrO₃ (BZO) in BaFe₂(As_{0.67}P_{0.33})₂, was prepared.

Element mapping was performed with respect to the iron-based superconducting layers of Example C, Example D, and Example E by TEM to measure a particle size and a volume density of BZO nanoparticles contained in the iron-based superconducting layers of Example C, Example D, and Example E.

As a result, it was confirmed that randomly oriented BZO nanoparticles having an average particle size of 8 nm were dispersed in the iron-based superconducting layer of Example C in a volume density of 1.2×10²³m⁻³In addition, it was confirmed that randomly oriented BZO nanoparticles having an average particle size of 7 nm were dispersed in the iron-based superconducting layer of Example D in a volume density of 3.9×10²³m⁻³.

In addition, it was confirmed that randomly oriented BZO nanoparticles having an average particle size of 6 nm were dispersed in the iron-based superconducting layer of Example E in a volume density of 6.0×10²³m⁻³

Measurement of J_{c} in a magnetic field of 1T_{c} which was applied in the c-axis direction at 5 K, was performed with respect to the iron-based superconducting layer of Example C, Example D, and Example E. From the measurement, J_{c} of the iron-based superconducting layer of Example C was 3.1 MA/cm², J_{c} of the iron-based superconducting layer of Example D was 3.7 MA/cm², and J of the iron-based superconducting layer of Example E was 1.9 MA/cm².

When comparing with Comparative Example A in Test Example 1 in which J_{c} in a magnetic field of 1T applied in the c-axis direction at 5 K was 1.1 MA/cm², J_{c} of the iron-based superconducting layer of Example C was 2.9 times J_{c} of Comparative Example A, J of the iron-based superconducting layer of Example D was 3.4 times J of Comparative Example A, and J_{c} of the iron-based superconducting layer of Example E was 1.7 times J_{c} of Comparative Example A. From these results, it was confirmed that it was possible to suppress a decrease in J_{c} during magnetic field application.

When comparing Example C, Example D, and Example E, it can be seen that an effect of suppressing the decrease in J_{c} of Example E in which the volume density of the BZO nanoparticles is the highest decreases. The reason of this is considered to be because the density of the BZO nanoparticles is high and thus crystallinity (c-axis orientation degree) of the iron-based superconducting layer deteriorates. To confirm this observation, T_{c}zero of Example E was measured. At the measurement, the value was 21.5 K, and a decrease by 5 K was confirmed. That is, in the iron-based superconducting layer of Example E, it was confirmed that the volume density of the BZO nanoparticles was high, and thus crystallinity deteriorated.

### Test Example 3

Next, only the composition of the target was changed in comparison to Test Example 1 to prepare iron-based superconducting wire materials of Example a, Example b, Example c, Comparative Example a, Comparative Example b, and Comparative Example c. As a target in Test Example 3, a target in which a composition ratio of As and P was changed in comparison to Test Example 1 was used.

As a target of Comparative Example a, a target containing BaFe₂(As_{0.75}P_{0.25})₂ was used.

In addition, as a target of Example a, a target obtained by containing 3 mol % of BZO in BaFe₂(As_{0.75}P_{0.25})₂ was used.

As a target of Comparative Example b, a target containing BaFe₂(As_{0.60}P_{0.40})₂ was used.

In addition, as a target of Example b, a target obtained by containing 3 mol % of BZO in BaFe₂(As_{0.60}P_{0.40})₂ was used.

As a target of Comparative Example c, a target containing BaFe₂(As_{0.5}P_{0.5})₂ was used.

In addition, as a target of Example c, a target obtained by containing 3 mol % of BZO in BaFe₂(As_{0.50}P_{0.50})₂ was used.

Examination on a composition of P in a layer was performed with respect to the iron-based superconducting layers formed using the targets of Examples and Comparative Examples according to EPMA analysis. From the examination, it could be seen that a composition ratio of P with respect to As was less than the target composition by approximately 0.05 regardless of whether or not BZO was contained.

More specifically, the composition ratio of As and P was 0.81:0.19 in Comparative Example a and Example a, the composition ratio was 0.65:0.35 in Comparative Example b and Example b, and the composition ratio was 0.55:0.45 in Comparative Example c and Example c.

T_{c}zero (temperature when a resistance value becomes zero) of the iron-based superconducting layers of the iron-based superconducting wire materials, which were prepared using the above-described targets, was measured. In addition, measurement of J in a magnetic field of 1T applied in the c-axis direction at 5 K was performed with respect to the iron-based superconducting layers of Examples and Comparative Examples. Measurement results of Examples and Comparative Examples are shown in Table 1.

TABLE 1

| | | COMPOSITION | | |
|---|---|---|---|---|
| | | RATIO OF AS AND P | | |
| | | IN IRON-BASED | | |
| | | SUPERCONDUCTING | | J_{c} in 1 T |
| | COMPOSITION | LAYER | T_{c}zero | at 5K |
| | OF TARGET | As:P | [K] | [MA/cm²] |
| COMPARATIVE | BaFe₂(As_{0.75}P_{0.25})₂ | 0.81:0.19 | 16 | 0.09 |
| EXAMPLE a | | | | |
| EXAMPLE a | BaFe₂(As_{0.75}P_{0.25})₂ + | 0.81:0.19 | 17 | 0.11 |
| | 3 mol % of BZO | | | |
| COMPARATIVE | BaFe₂(As_{0.60}P_{0.40})₂ | 0.65:0.35 | 25.5 | 0.9 |
| EXAMPLE b | | | | |
| EXAMPLE b | BaFe₂(As_{0.60}P_{0.40})₂ + | 0.65:0.35 | 25.0 | 2.2 |
| | 3 mol % of BZO | | | |
| COMPARATIVE | BaFe₂(As_{0.50}P_{0.50})₂ | 0.55:0.45 | 21.4 | 0.4 |
| EXAMPLE c | | | | |
| EXAMPLE c | BaFe₂(As_{0.50}P_{0.50})₂ + | 0.55:0.45 | 21.3 | 0.8 |
| | 3 mol % of BZO | | | |

From Table 1, it was confirmed that when BZO was contained, a phenomenon such as a great decrease in T_{c}zero was not found.

In the iron-based superconducting layers of Comparative Example a and Example a, J_{c} in a magnetic field of 1T applied in the c-axis direction at 5 K was lowered. This is considered to be because a transition width was broadened due to the composition ratio of As and P.

In a case of expressing the composition ratio of As and P as As:P=1−y:y, it is preferable that the composition of As and P satisfy a relationship of 0.2≦y≦0.45. According to this, the iron-based superconducting material can exhibit stable J_{c} and T_{c}. However, the iron-based superconducting wire materials of Comparative Example a and Example a deviated the above-described range, and as a result, J_{c} was significantly low.

When comparing Comparative Example a and Example a, Comparative Example b and Example b, and Comparative Example c and Example c, respectively, it can be seen that when BZO is contained, J_{c} of respective Examples becomes higher. That is, it was confirmed that it is possible to suppress a decrease in J_{c} due to magnetic field application by introducing the BZO nanoparticles in the iron-based superconducting layers.

### Test Example 4

Next, only the composition of the target was changed in comparison to Test Example 1 to prepare iron-based superconducting wire materials of Example d, Example e, Comparative Example d, and Comparative Example e. As a target in Test Example 4, a target, which was obtained by substituting Ba with Sr in a ratio of 50% or 100% in comparison to Test Example 1, was used.

As a target of Comparative Example d, a target containing (Ba_{0.5}Sr_{0.5})Fe₂(As_{0.67}P_{0.33})₂ was used.

In addition, as a target of Example d, a target obtained by containing 3 mol % of BZO in (Ba_{0.5}Sr_{0.5})Fe₂(As_{0.67}P_{0.33})₂ was used.

As a target of Comparative Example e, a target containing SrFe₂(As_{0.67}P_{0.33})₂ was used.

In addition, as a target of Example e, a target obtained by containing 3 mol % of BZO in SrFe₂(As_{0.67}P_{0.33})₂ was used.

T_{c}zero (temperature when a resistance value becomes zero) of the iron-based superconducting layers of the iron-based superconducting wire materials, which were prepared using the above-described targets, was measured. In addition, measurement of J_{c} in a magnetic field of 1T applied in the c-axis direction at 5 K was performed with respect to the iron-based superconducting layers of Examples and Comparative Examples. Measurement results of Examples and Comparative Examples are shown in Table 2.

TABLE 2

| | | | J_{c} in 1 T |
|---|---|---|---|
| | | T_{c}zero | at 5K |
| | COMPOSITION OF TARGET | [K] | [MA/cm²] |
| COMPARATIVE | (Ba_{0.5}Sr_{0.5})Fe₂(As_{0.67}P_{0.33})₂ | 26.0 | 0.8 |
| EXAMPLE d | | | |
| EXAMPLE d | (Ba_{0.5}Sr_{0.5})Fe₂(As_{0.67}P_{0.33})₂ + 3 | 25.5 | 2.0 |
| | mol % of BZO | | |
| COMPARATIVE | SrFe₂(As_{0.67}P_{0.33})₂ | 24.0 | 0.5 |
| EXAMPLE e | | | |
| EXAMPLE e | SrFe₂(As_{0.67}P_{0.33})₂ + 3 mol % of | 23.0 | 1.1 |
| | BZO | | |

From Table 2, it was confirmed that when BZO was contained, a phenomenon such as a great decrease in T_{c}zero was not found.

In addition, when comparing Comparative Example d and Example d, and Comparative Example e and Example e, respectively, it can be seen that when BZO is contained, J_{c} of respective Examples becomes higher. That is, it was confirmed that it is possible to suppress a decrease in J_{c} due to magnetic field application by introducing the BZO nanoparticles in the iron-based superconducting layers.

Furthermore, measurement of magnetic field angle dependency of J_{c} was performed, and a decrease in anisotropy due to introduction of BZO was confirmed.

### Test Example 5

Next, the composition of the target was changed in comparison to Test Example 1 to prepare Example f, Example g, and Example h in which an iron-based superconducting layer having a thickness of 100 nm was formed.

As Example f, an iron-based superconducting wire material, in which the iron-based superconducting layer was formed using a target obtained by containing 3 mol % of BaSnO₃ (BSO) in BaFe₂(As_{0.67}P_{0.33})₂, was prepared.

As Example g, an iron-based superconducting wire material, in which the iron-based superconducting layer was formed using a target containing 3 mol % of BaHfO₃ (BHO), was prepared.

As Example h, an iron-based superconducting wire material, in which the iron-based superconducting layer was formed using a target containing 3 mol % of BaTiO₃ (BTO), was prepared.

X-ray diffraction analysis was performed with respect to the iron-based superconducting layer of Example f, Example g, and Example h.

From this analysis, in the iron-based superconducting layers of Examples, it was confirmed that the iron-based superconductor (122-type compound) oriented with c-axis orientation and in-plane orientation. In addition, in Example g and Example h in which BHO or BTO was contained in the target, a diffraction peak of the contained material (BHO or BTO) was observed. However, in Example fin which BSO was contained in the target, a diffraction peak of BSO was weak.

Element mapping was performed with respect to the iron-based superconducting layers of Example f, Example g, and Example h by TEM to measure a particle size and a volume density of BZO nanoparticles contained in the iron-based superconducting layers of Examples.

According to this, it was confirmed that BSO nanoparticles having a particle size of 5 nm or more, which is effective for the pinning effect, were dispersed in the iron-based superconducting layer of Example f in a volume density of 5×10²¹m⁻³

In addition, it was confirmed that randomly oriented BHO nanoparticles having an average particle size of 10 nm were dispersed in the iron-based superconducting layer of Example g in a volume density of 7×10²²m⁻³.

In addition, it was confirmed that randomly oriented BTO nanoparticles having an average particle size of 15 nm were dispersed in the iron-based superconducting layer of Example h in a volume density of 4×10²²m⁻³

T_{c}zero (temperature when a resistance value becomes zero) of the iron-based superconducting layers of the iron-based superconducting wire materials of Example f, Example g, and Example h was measured. In addition, measurement of J_{c} in a magnetic field of 1T applied in the c-axis direction at 5 K was performed with respect to the iron-based superconducting layers of Examples. Measurement results of Examples are shown in Table 3.

TABLE 3

| | | | J_{c} in 1 T |
|---|---|---|---|
| | | T_{c}zero | at 5K |
| | COMPOSITION OF TARGET | [K] | [MA/cm²] |
| EXAMPLE f | BaFe₂(As_{0.67}P_{0.33})₂ + | 27.5 | 1.2 |
| | 3 mol % of BSO | | |
| EXAMPLE g | BaFe₂(As_{0.67}P_{0.33})₂ + | 26.5 | 3.4 |
| | 3 mol % of | | |
| | BHO | | |
| EXAMPLE h | BaFe₂(As_{0.67}P_{0.33})₂ + | 25.0 | 2.7 |
| | 3 mol % of BTO | | |

From Table 3, it was confirmed that when BSO, BHO, or BTO was contained, a phenomenon such as a great decrease in T_{c}zero was not found.

When comparing with Comparative Example A in Test Example 1 in which J_{c} in a magnetic field of 1T applied in the c-axis direction at 5 K was 1.1 MA/cm², it can be seen that when BSO, BHO, or BTO is contained, J_{c} of respective Examples becomes higher. That is, it was confirmed that it is possible to suppress a decrease in J_{c} due to magnetic field application by introducing the BZO nanoparticles in the iron-based superconducting layers.

In Example f, the BSO nanoparticles having a particle size of 5 nm or more, which is effective for the pinning effect, were dispersed in a volume density of 5×10²¹m⁻³, and thus the volume density of remaining nanoparticles became lower in comparison to the BHO nanoparticles of Example g and the BTO nanoparticles of Example h. In addition, the volume density of the remaining nanoparticles was lower in comparison to the BZO nanoparticles of Example B in Test Example 1. Accordingly, it is considered that the iron-based superconducting layer of Example f has the effect of suppressing a decrease in J_{c} which is lower in comparison to Example g, Example h, and Example B.

### Test Example 6

Next, the composition of the target was changed in comparison to Test Example 1 to prepare Example 1, Example 2, Example 3, Comparative Example 1, Comparative Example 2, and Comparative Example 3 in which an iron-based superconducting layer having a thickness of 100 nm was formed.

As a target of Comparative Example 1, a target containing Ba(Fe_{0.93}Cu_{0.07})₂As₂ was used.

In addition, as a target of Example 1, a target obtained by containing 3 mol % of BZO in Ba(Fe_{0.93}Cu_{0.07})₂As₂ was used.

As a target of Comparative Example 2, a target containing Ba(Fe_{0.90}Co_{0.10})₂As₂ was used.

In addition, as a target of Example 2, a target obtained by containing 3 mol % of BZO in Ba(Fe_{0.90}Co_{0.10})₂As₂ was used.

As a target of Comparative Example 3, a target containing Ba(Fe_{0.86}Cu_{0.14})₂As₂ was used.

In addition, as a target of Example c, a target obtained by containing 3 mol % of BZO in Ba(Fe_{0.86}Co_{0.14})₂As₂ was used.

X-ray diffraction analysis was performed with respect to the iron-based superconducting layers of Comparative Example 1, Comparative Example 2, and Comparative Example 3.

From this analysis, in the iron-based superconducting layer of Comparative Examples, it was confirmed that the iron-based superconductor (122-type compound) oriented with c-axis orientation and in-plane orientation.

In addition, examination on a composition of Co in a layer was performed respect to the iron-based superconducting layers of Comparative Example 1, Comparative Example 2, and Comparative Example 3 according to EPMA analysis, it could be seen that a composition ratio of Co with respect to Fe slightly decreased in comparison to the target composition. Specifically, the composition ratio of Fe and Co was 0.94:0.06 in Comparative Example 1, the composition ratio was 0.915:0.085 in Comparison Example 2, and the composition ratio was 0.87:0.13 in Comparative Example 3.

T_{c}zero (temperature when a resistance value becomes zero) of the iron-based superconducting layers of Example 1, Example 2, Example 3, Comparative Example 1, Comparative Example 2, and Comparative Example 3 was measured. In addition, measurement of J_{c} in a magnetic field of 1T applied in the c-axis direction at 5 K was performed with respect to the iron-based superconducting layers of Examples and Comparative Examples. Measurement results of Examples and Comparative Examples are shown in Table 4.

TABLE 4

| | | COMPOSITION | | |
|---|---|---|---|---|
| | | RATIO OF Fe AND Co | | |
| | | IN IRON-BASED | | |
| | | SUPERCONDUCTING | | J_{c} in 1 T |
| | COMPOSITION | LAYER | T_{c}zero | at 5K |
| | OF TARGET | Fe:Co | [K] | [MA/cm²] |
| COMPARATIVE | Ba(Fe_{0.93}Co_{0.07})₂As₂ | 0.94:0.06 | 18.5 | 0.10 |
| EXAMPLE 1 | | | | |
| EXAMPLE 1 | Ba(Fe_{0.93}Co_{0.07})₂As₂ + | | 18.3 | 0.12 |
| | 3 mol % of BZO | | | |
| COMPARATIVE | Ba(Fe_{0.90}Co_{0.10})₂As₂ | 0.915:0.085 | 21.5 | 0.41 |
| EXAMPLE 2 | | | | |
| EXAMPLE 2 | Ba(Fe_{0.90}Co_{0.10})₂As₂ + | | 21.1 | 0.57 |
| | 3 mol % of BZO | | | |
| COMPARATIVE | Ba(Fe_{0.86}Co_{0.14})₂As₂ | 0.87:0.13 | 19.5 | 0.23 |
| EXAMPLE 3 | | | | |
| EXAMPLE 3 | Ba(Fe_{0.86}Co_{0.14})₂As₂ + | | 19.0 | 0.30 |
| | 3 mol % of BZO | | | |

From Table 4, it was confirmed that when BZO was contained, a phenomenon such as a great decrease in T_{c}zero was not found.

In this Test Example, measurement of a composition ratio of Fe and Co in the iron-based superconducting layer of Example 1, Example 2, and Example 3 in which BZO was contained was not performed. However, in Test Example 3, it was confirmed that whether or not BZO was contained did not have an effect on the composition ratio of the iron-based superconductor in the iron-based superconducting layer. Accordingly, it is considered that the composition ratio of Example 1 is equal to the composition ratio of Fe and Co in the iron-based superconducting layer of Comparative Example 1, the composition ratio of Example 2 is equal to the composition ratio of Fe and Co in the iron-based superconducting layer of Comparative Example 2, and the composition ratio of Example 3 is equal to the composition ratio of Fe and Co in the iron-based superconducting layer of Comparative Example 3.

In a case of expressing the composition ratio of Fe and Co as Fe:Co=1−p:p, it is preferable that the composition of Fe and Co satisfy a relationship of 0.06≦p≦0.13. According to this, the iron-based superconducting material can exhibit stable J_{c} and T_{c} close to 20 K.

The iron-based superconducting layers of Example 1, Example 2, Example 3, Comparative Example 1, Comparative Example 2, and Comparative Example 3 satisfy the above-described condition, and thus the iron-based superconducting layers can exhibit stable J_{c} and T_{c}.

As shown in Table 4, when comparing Comparative Example 1 and Example 1, Comparative Example 2 and Example 2, and Comparative Example 3 and Example 3, respectively, it can be seen that when BZO is contained, J_{c} of respective Examples becomes higher. That is, it was confirmed that it is possible to suppress a decrease in J_{c} due to magnetic field application by introducing the BZO nanoparticles in the iron-based superconducting layers.

### Test Example 7

Raw materials of Ba, K, FeAs, and Ag were mixed in a molar ratio of 0.7:0.48:2:0.5, the resultant mixed material was put into a boron nitride (BN) crucible, the crucible was vacuum-sealed with a SUS pipe, and the mixed material was baked at 1100° C. to prepare a polycrystalline substance of (Ba, K)Fe₂As₂.

The composition of K that was contained in the polycrystalline substance was examined by composition analysis according to ICP emission spectrometric analysis, and it could be seen that the composition of K slightly decreased in comparison to the composition of K that was put into the crucible. Specifically, as a composition ratio of K to Ba (Ba:K) was 0.61:0.39.

The polycrystalline substance had a substantially single composition of Ba122, and T_{c} evaluated by measurement of magnetic susceptibility was 36.6 K.

Next, the polycrystalline substance was pulverized and was packed in an Ag pipe having an inner diameter of 4 mm and a thickness of 1 mm. The polycrystalline substance was processed into a wire having an outer diameter of approximately 2 mm in a drawing process at room temperature, and then a linear body obtained by the process was cut in a length of 4 cm. Furthermore, the linear body obtained after the cutting was vacuum-sealed with a SUS pipe, and a heat treatment was performed at 860° C. for 36 hours to prepare an Ag sheath iron-based superconducting wire of Comparative Example 4.

On the other hand, 10 mol % of a BaSnO₃ (BSO) powder that was pulverized into a fine powder was mixed with the polycrystalline substance of (Ba, K)Fe₂As₂ using a ball mill, the resultant mixed material was packed in an Ag pipe having an inner diameter of 4 mm and a thickness of 1 mm in the same manner as Comparative Example 4. The mixed material was processed into a wire having an outer diameter of approximately 2 mm in a drawing process at room temperature, and then a linear body obtained by the process was cut in a length of 4 cm. Furthermore, the linear body obtained after the cutting was vacuum-sealed with a SUS pipe, and a heat treatment was performed at 860° C. for 36 hours to prepare an Ag sheath iron-based superconducting wire of Example 4.

The critical current density J_{c} of the Ag sheath iron-based superconducting wire of Comparative Example 4 was evaluated at 4.2 K, and a value of 7500 A/cm² was obtained in a zero magnetic field, and a value of 800 A/cm² was obtained in a magnetic field of 5 T.

Similarly, the critical current density J_{c} of the Ag sheath iron-based superconducting wire of Comparative Example 4 was evaluated at 4.2 K, and a value of 865 A/cm² was obtained in a magnetic field of 5 T. That is, J_{c} was improved.

A microstructure of a core of the Ag sheath iron-based superconducting wire of Example 4 was observed. From the observation, it could be seen that a particle size of most BSO nanoparticles was 100 nm or more, but nanoparticles having a particle size of 30 nm or less were present in a volume density of 6×10²¹m⁻³. It is considered that a decrease in J_{c} during magnetic field application was suppressed due to the BSO nanoparticles.

In addition, T_{c} of Comparative Example 4 was 36.1 K, and T_{c} of Example 4 was 36.0 K. A significant variation in T_{c} due to dispersion of the BSO nanoparticles was not found.

A polycrystalline substance having a composition ratio of Ba:K=0.76:0.26 and a polycrystalline substance having a composition ratio of Ba:K=0.35:0.66 were formed, respectively, in the same sequence as Example 4, and 10 mol % of BSO was mixed in these polycrystalline substances to prepare an Ag sheath iron-based superconducting wire of Example 5 and an Ag sheath iron-based superconducting wire of Example 6 were prepared.

The critical current density J of the Ag sheath iron-based superconducting wires of Example 5 and Example 6 was evaluated at 4.2 K. From the evaluation, it could be seen that the critical current density J_{c} of Example 5 and Example 6 was improved in comparison to the critical current density J_{c} of the Ag sheath iron-based superconducting wire of Comparative Example 4 during magnetic field application.

In addition, T_{c} of Example 5 was 30.8 K, and T_{c} of Example 6 was 29.6 K.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An iron-based superconducting material, comprising:
an iron-based superconductor having a crystal structure of ThCr₂Si₂; and
nanoparticles which are expressed by BaXO₃ (X represents one, two, or more kinds of elements selected from the group consisting of Zr, Sn, Hf, and Ti) and have a particle size of 30 nm or less,
wherein the nanoparticles are dispersed in a volume density of 1×10²¹m⁻³ or more.

2. The iron-based superconducting material according to claim 1, wherein the iron-based superconductor having the crystal structure of ThCr₂Si₂ is AFe₂₊ₓ(As_{1-y}, P_{y})_{2-z}(A represents one or two kinds of elements selected from the group consisting of Ba and Sr, −0.2≦x≦0.2, 0.2≦y≦0.45, and 0≦z≦0.2).

3. The iron-based superconducting material according to claim 1, wherein the iron-based superconductor having the crystal structure of ThCr₂Si₂ is (A_{1-α}, K_{α})Fe_{2+β}As_{2-γ}(A represents at least one selected from the group consisting of Ba and Sr, 0.25≦c≦0.65, −0.2≦β≦0.2, and 0≦γ≦0.2).

4. The iron-based superconducting material according to claim 1, wherein the iron-based superconductor having the crystal structure of ThCr₂Si₂ is A(Fe₁₋ₚ, Coₚ)_{2+q}As₂₋ᵣ (A represents one or two kinds of elements selected from the group consisting of Ba and Sr, 0.06≦p≦0.13, −0.2≦q≦0.2, and 0≦r≦0.2).

5. The iron-based superconducting material according to claim 1,
wherein the particle size of the nanoparticles is 5 to 15 nm.

6. The iron-based superconducting material according to claim 1,
wherein the nanoparticles are dispersed in a volume density of 1×10²²m⁻³ to 6×10²³m⁻³.

7. An iron-based superconducting layer constituted by the iron-based superconducting material according to claim 1.

8. An iron-based superconducting tape wire material, comprising:
an iron-based superconducting layer which is constituted by the iron-based superconducting material according to claim 1 and is formed on a metal tape base material.

9. An iron-based superconducting wire material, comprising:
the iron-based superconducting material according to claim 1 which is filled in a metal sheath.
